(19) United States
(12) Patent Application Publication
(10) Pub. No.: US 2005/0213634 A1
(43) Pub. Date: Sep. 29, 2005

(54) Remote measurement and control for a heating element

(76) Inventor: Avraham Sadeh, RaAnana (IL)

Correspondence Address: Martin Moynihan;c/o Anthony Castorina, Suite 207, 2001 Jefferson Davis Highway, Arlington, VA, 22202, US

(21) Appl. No.: 11/131,362

(22) Filed: May 18, 2005

Related U.S. Application Data
(63) Continuation-in-part of application No. PCT/IL03/00979, filed on Nov. 19, 2003.

(30) Foreign Application Priority Data
Nov. 19, 2002 (IL) 152948

(51) Int. Cl. G01K 15/00

(52) U.S. Cl. 374/147; 374/1; 374/185

(57) ABSTRACT

Apparatus for remotely and/or non-invasively obtaining a temperature of a fluid being heated by an electrical heating element, the apparatus comprising: a switch for governing supply of electrical power to said heating element, said switch being controllable to stop the supply of said electrical power to said electrical heating element for a duration sufficient for said heating element to reach temperature equilibrium with said fluid, a signal generation unit, coordinated with said switch, for sending an electrical signal to said heating element when said heating element has reached said temperature equilibrium, and a measurement unit for measuring a measurable property of said electrical signal, said measurable property having a temperature dependency, to determine the temperature of said heating element and thereby to infer the temperature of said fluid.

### RELATIONSHIP TO EXISTING PATENT APPLICATIONS

The present application is a continuation-in-part of PCT/IL03/00979, filed Nov. 19, 2003, which in turn claims priority from Israel Patent Application No. 152,948 filed Nov. 19, 2002. The contents of both the aforementioned applications are hereby incorporated herein by reference.

### FIELD AND BACKGROUND OF THE INVENTION

The present invention relates to remote measurement and control for a heating element and, more particularly, but not exclusively to such remote measurement and control which can be applied externally to an existing installation without requiring internal modifications to the existing installation.

Generally, installations involving heating elements, such as water heating installations use thermostats and control loops in order to maintain the temperature of the water at a predetermined temperature. However, temperature measurement requires a sensor placed in the water, and the addition of such control to an existing uncontrolled installation, or the replacement of a failed element, requires internal access to the boiler. Access to the boiler may not always be easy and the boiler cannot be operated whilst access is made. Furthermore, sensors are often the first elements to fail in a control arrangement and it is desirable to make control arrangements more reliable.

A further problem with existing control installations is that they generally indicate to an outside user that the control system is operating, but do not provide an indication as to whether the heating element is currently operating. Thus the user is unable to know when the water is actually hot. Furthermore, any indication that is provided is not independent of the control installation. Thus in the event of malfunction of the thermostat, the control system may indicate that it is operating and yet the water is not in fact being heated.

U.S. Pat. No. 4,736,091 to John L. Moe describes an integral sensor controller for an electrical resistance heater, where the heater is constructed from materials such as nickel, balco, platinum, alumel, or like materials which have an appreciable, positive temperature coefficient of resistivity. The resistance versus temperature characteristic of the heater acts as the temperature sensor. A low level D.C. current provides a sensor voltage which is compared to a set point voltage for switching the heater power through a transistor. The relationship of the sensor voltage to the set point voltage is compared by a comparator which is subsequently used to toggle flip flops for switching of the heater power. Circuitry is provided for protection against heater short circuits. The disclosure explains how to measure the temperature of the heating element but does not explain how to determine the temperature of the water being heated. Furthermore there is no explanation of how to discount heating effects in the connecting wires, which do affect the resistance characteristic.

U.S. Pat. No. 4,317,987 to Fieldman discloses a remote control device for controlling the operation of a conventional domestic water heater used singularly or in conjunction with a solar heating system. The control device comprises a remote control head, which has an indicator for conveying the status of the water heater and the temperature of the water contained therein and a multi-positional manual switch for selecting the mode of operation of the water heater and a remote controlled heater switch, electrically connected to the remote control head, which controls power to the water heater in response to signals from the remote control head. Therefore, the operation of the water heater can be controlled according to the needs of the user. However the system does not provide accurate non-invasive measurement of the water temperature.

There is thus a widely recognized need for, and it would be highly advantageous to have, a control system devoid of the above limitations.

### SUMMARY OF THE INVENTION

According to one aspect of the present invention there is provided apparatus for remotely obtaining a temperature of a fluid being heated by an electrical heating element, the apparatus comprising:

a switch for governing supply of electrical power to said heating element, said switch being controllable to stop the supply of said electrical power to said electrical heating element for a duration sufficient for said heating element to reach temperature equilibrium with said fluid,

a signal generation unit, coordinated with said switch, for sending an electrical signal to said heating element when said heating element has reached said temperature equilibrium, and

a measurement unit for measuring a measurable property of said electrical signal, said measurable property having a temperature dependency, to determine the temperature of said heating element and thereby to infer the temperature of said fluid.

According to this aspect of the invention the heating element and its connecting wires are the only requirements for carrying out the temperature measurement and thus an embodiment may be provided in which an existing water heater can be provided with temperature monitoring in non-invasive fashion, that is by adding external components only.

Preferably, said electrical heating element comprises inductance and said property is associated with said inductance.

Additionally or alternatively, said electrical heating element comprises inductance, and wherein a capacitive element is connected in series with said electrical heating element, thereby to create a temperature dependent resonance as said measurable property.

Additionally or alternatively, said measurable property is resistance.

Additionally or alternatively, said signal is a predefined signal and said measurable property is noise.

Additionally or alternatively, said measurable property is impedance.

Additionally or alteratively, said measurable property is inductance.

An embodiment further comprises a detector unit for measuring power being supplied to said heating element, thereby to provide an indication that said heating element is operational.

Preferably, said detector unit comprises an optical coupling to an isolated indicator circuit, said optical coupling being operational when power is supplied to said heating element to power said optical coupling to operate said indicator circuit.

Preferably, said detector unit comprises a voltage divider and a light emitting diode.

A preferred embodiment may comprise a power supply, said power supply comprising a diode-based rectification bridge, said bridge being connected between two impedance elements of a voltage divider.

A preferred embodiment may comprise a calibration table associated with said measurement unit, for calibrating measurements for a respective heating element.

A preferred embodiment may comprise an emergency power source, said emergency power source comprising a capacitance and a resistance connected in series, and having values selected to provide current in the microampere range at low voltage for a duration of several hours.

According to a second aspect of the present invention there is provided a method for remotely measuring the temperature of a fluid in contact with an electric heating element, the method comprising:

heating said fluid via said heating element,

cutting power to said heating element for sufficient time to allow said heating element to reach equilibrium temperature with said fluid,

applying a signal to said heating element,

taking a measurement of said signal, said measurement being of a temperature dependent property, therefrom to determine said equilibrium temperature of said heating element to infer said temperature of said fluid.

The method preferably comprises providing a capacitance in series with said heating element, thereby to provide a resonant circuit, and wherein said temperature dependent property is an impedance-related deviation from the resonant frequency thereof.

Preferably, said signal comprises a defined waveform and said temperature dependent property is a noise level.

Additionally or alternatively, said temperature dependent property is resistance.

Additionally or alternatively, said temperature dependent property is inductance.

Additionally or alternatively, said temperature dependent property is impedance.

The method preferably comprises a prior stage of calibrating for a respective heating element.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram showing a heating control circuit according to a first preferred embodiment of the present invention;

FIG. 2 is a simplified graph showing a noise-temperature characteristic and a straight line approximation of the same;

FIG. 3 is a simplified graph showing an inductance-temperature characteristic and a straight line approximation of the same;

FIG. 4 is a simplified graph showing a resistance temperature characteristic with a straight line approximation of the same;

FIG. 5 is a simplified flow chart illustrating a procedure for measuring the temperature of a fluid according to a preferred embodiment of the present invention; and

FIG. 6 is a circuit diagram showing a heating control circuit according to a preferred embodiment of the present invention.

### DESCRIPTION OF THE PREFERRED EMBODIMENTS

The present embodiments comprise a method and apparatus for determining the temperature of the water remotely without having a sensor within the boiler. The embodiments allow the heating element to reach temperature equilibrium with the surrounding water and then measurements: are made of signals emanating from the heating element to determine the temperature of the heating element and thereby infer the water temperature. The signals emanating from the heating element may be any signal that contains temperature information. As examples, the temperature-related resistance effect, the temperature related resonance effect, temperature-related noise effects and the like can be used to deduce a temperature from the signal emanating from the element.

Embodiments of the invention also comprise a thermostat-independent way of notifying a user as to whether or not the thermostat is currently working.

Preferred embodiments furthermore ensure that the remote measurement apparatus provided is safe for a technician to work on, and does not present any substantial danger of electrocution.

The preferred embodiments allow measurement and control to be applied to a water heater or boiler system or the like without needing to make any changes within the water heater itself. All of the control and measurement can be applied using external components only.

The principles and operation of a remote measurement and control system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

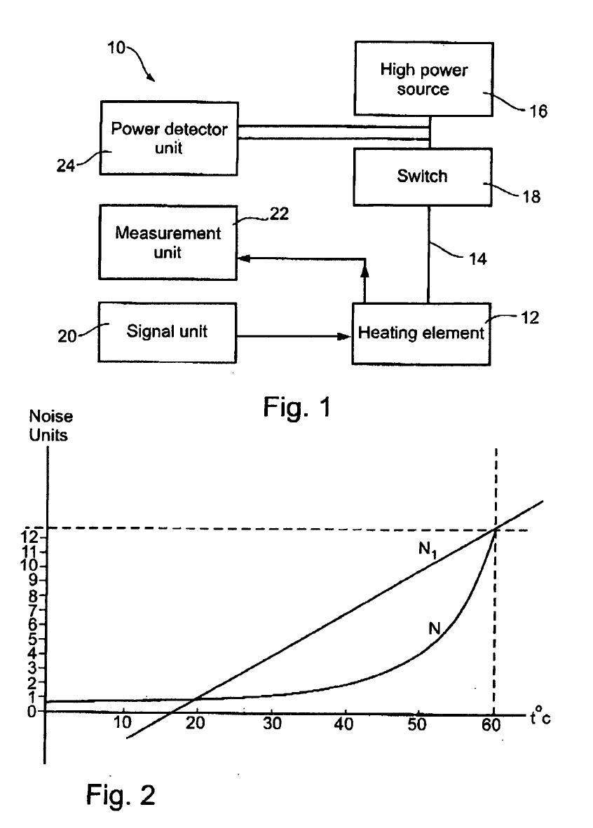

Reference is now made to FIG. 1, which is a simplified block diagram illustrating apparatus 10 for remotely obtaining a temperature of a fluid being heated by an electrical heating element, thus for example water being heated in a boiler system. The apparatus comprises a heating element 12 which is located within the fluid heating environment. The heating element typically has a certain level of resistivity and a certain inductance, both of which levels have a certain temperature dependence. The heating element is powered via a power supply line 14 from a power source 16.

Along the power supply line 14 is located a switch 18 for governing supply of electrical power to heating element 12. The switch 18 is controlled to stop the supply of electrical power to said heating element 12 for a duration sufficient for the heating element to reach temperature equilibrium with the fluid. The exact time required depends on the accuracy of measurement required and on the dimensions and material of the heating element but may typically be of the order of magnitude of a minute.

Away from the power supply line is a signal generation unit 20, which is coordinated with switch 18, for sending an electrical signal to the heating element when the heating element has reached temperature equilibrium with the fluid but is still unpowered. The signal follows a path through the heating element and is then measured at measurement unit 22. Measurement unit 22 measures a property of the electrical signal which is temperature dependent. The measurement determines the temperature of the heating element 12 from which is inferred the temperature of the fluid.

The dimensions and properties of each heating element are such that it is preferable to provide a calibration table for each element. The calibration table allows for discrepancies such as energy dissipation in the connecting wires to be discounted.

The specific temperature dependent property that is used in specific cases varies according to circumstances and requirements. In one preferred embodiment the property to be measured is noise. Levels of noise are temperature dependent and it is possible to send a waveform of a predetermined shape and measure the amount of noise in the return signal. Reference is now made to FIG. 2, which shows a typical curve N of noise against temperature. The curve can be used directly or it is possible to sacrifice accuracy for simplicity and use a straight line approximation N1.

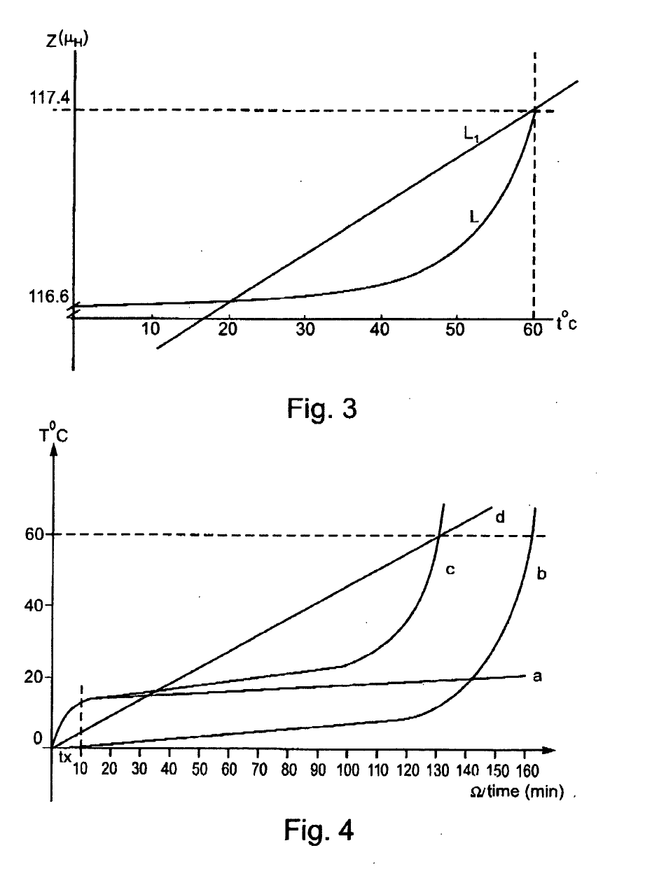

Reference is now made to FIG. 3, which is a simplified graph illustrating the variation L of inductance with temperature. It is possible to use direct inductance measurements to determine the temperature. However in a preferred embodiment, a capacitance is connected in series with the heating element to create a resonant circuit. As the inductance changes so does the resonant frequency and thus detection of a tendency to move away from resonance at a given frequency is an indirect but sensitive way of determining the temperature in the heating element. It is noted that the given frequency is a fixed frequency.

Likewise, resistance within the element ovaries with temperature and can be measured and the overall impedance also changes. Both of these can be measured directly or indirectly. Reference is now made to FIG. 4, which is a graph illustrating the resistance characteristic for the present embodiments. In the case of resistance, the connecting wires also have a resistance which changes with temperature. However the connecting wires tend to reach an equilibrium temperature relatively quickly and then make no further contribution to changes in resistance. Thus the effect due to the connecting wires can be discounted by switching on the signal path at the start of the heating procedure, then waiting for a small delay to allow the wires to reach an equilibrium temperature and then making an initial resistance measurement that includes the effect of the connecting wires. Graph a illustrates the initial effect of the connecting wires. Graph b illustrates the effect of the heating element. Graph c illustrates the resultant of a and b, and graph d is a straight line approximation of the resultant.

A particularly preferred embodiment uses a combination of the above properties in order to improve accuracy in the determination of the water temperature.

Returning to FIG. 1, and a power detector unit 24 is used to provide independent detection of the flow of power to the heating element. The idea is to provide a visual indicator to the user when the element is switched on, with the connotation that the water is currently not at the preset temperature. The indication is independent of the actual thermostat, and furthermore may be provided using hardware circuitry independently of any integrated circuit. The latter overcomes any limitations on pin outputs from the integrated circuit.

In one embodiment the detector unit comprises an optical coupling between the power line and an isolated indicator circuit. The optical coupling becomes operational when power is supplied to the heating element, and the indicator circuit is switched on.

Preferably, the detector unit comprises a voltage divider and a light emitting diode, arranged such that a voltage appears across the LED whenever a current flows in the power line. The LED is lit and switches on an optical transistor on the indicator circuit.

The measurement, signaling and indicator units are preferably powered by a low power supply. The low power supply comprises a diode-based rectification bridge which is connected between two impedance elements of a voltage divider.

As discussed above, a calibration table is preferably used with the measurement unit, for calibrating measurements for a respective heating element.

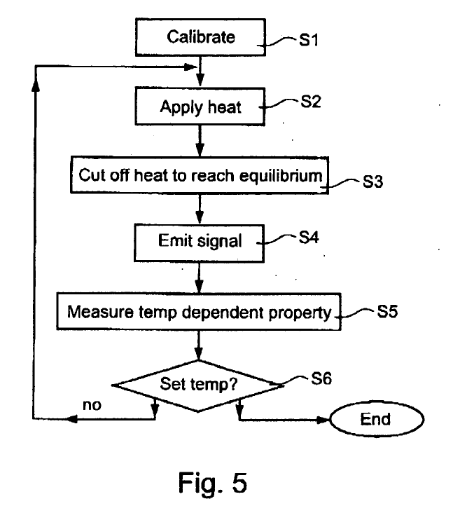

Reference is now made to FIG. 5, which is a simplified flow chart illustrating a temperature measurement procedure according to the present invention. A first stage S1 comprises calibration of the temperature related property for the given element. A calibration table is constructed as described above. S2 involves heating the fluid via the heating element. S3 involves stopping the heating for a period of time sufficient to enable the element to reach equilibrium with the fluid. S4 involves outputting a signal and S5 involves making a determination of the temperature based on the output resulting from the signal. Stage S6 is a decision stage in which the actual temperature is compared to a target temperature. If the actual temperature has reached the target temperature then the procedure ends for the time being. If the actual temperature is below the target temperature then heating is resumed.

The way in which heating is ended depends on whether the heater is set for one off heating of the water, in which case the process ends at this point, or whether it is set for automatic or timed mode, in which the process waits until the temperature reaches a lower set point and then resumes heating.

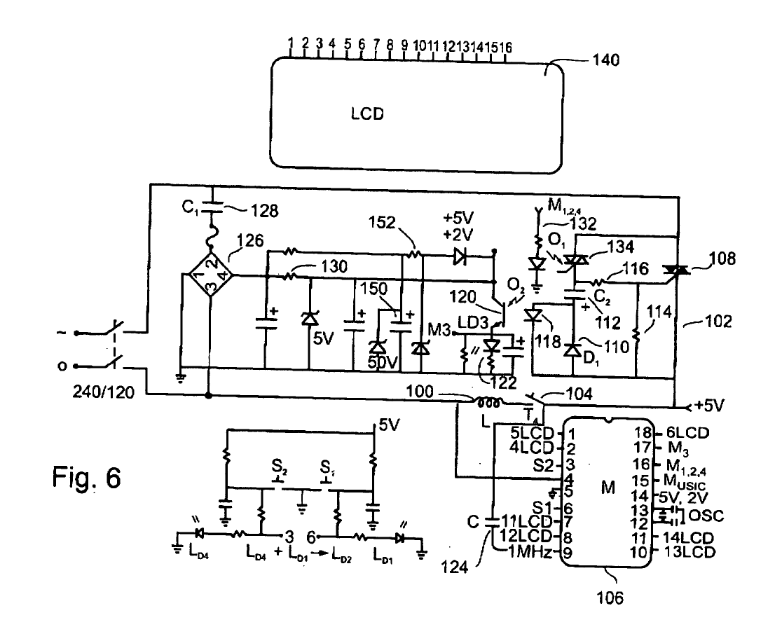

Reference is now made to FIG. 6, which is a simplified circuit diagram illustrating a preferred embodiment of the present invention. Water heating element 100 is connected to a power supply line 102. Power from the power supply line to the heating element 100 is controlled by a thermostat 104. The thermostat is controlled by microprocessor 106.

Power supply is via a triad 108. A voltage divider arrangement is constructed around the triac and comprises rectifier diode D1 110, capacitor C2 112, and resistors 114 and 116. The rectifier comprises rectifier diode D1 110 and storage capacitor C2 112 and is located between the anode and the cathode legs of the triac. As long as a current flows through the power supply circuit, a voltage appears across the voltage divider and causes a current to flow over LED D2 118. Light from the LED 118 operates light controlled transistor 120 which in turn lights blue LED 122. The blue LED 122 thus serves as an independent indicator that the heating element is operating. Heating input M3 is provided to the microprocessor. In a preferred embodiment, a red LED operated by a suitable pin from microcontroller 106 may indicate that the water has reached a system predetermined temperature. At this point the thermostat is preferably opened. In an alternative embodiment the user or customer may set the temperature. At the time the set temperature is reached a suitable signal is sent from the monitoring circuit.

Returning to the heating element 100, element 100 is connected in series with a capacitor 124 in a signal circuit that starts and ends with microcontroller 106. The capacitor together with the inductance L of the heating element itself forms a resonant circuit. The inductance varies with the change in temperature of the element so that the overall impedance also varies with the temperature of the element. As explained above heating of the element is suspended for sufficient time to allow the element to reach equilibrium with the temperature of the water and then the temperature can be determined. The microcontroller is then able to use the calibration table to convert the impedance of the circuit that has been into a water temperature and then decide how to proceed. It is noted that in a series circuit the impendence is lowest when the temperature is lowest. At this point the circuit is in resonance. With heating of the water the impedance (under resonance) distances itself from the minimum. The impedance goes up, and the circuit recedes from resonance, showing that the temperature has changed upwardly. The frequency, is taken from the 1 MHz steady frequency (or any other steady frequency as appropriate for the circuit) obtained from pin 9 of the microprocessor resonance.

It is alternatively possible to construct the resonant circuit in parallel format. In such a case all the measurements are reversed and the impedance is a maximum at the center. Change in temperature leased to a reduction in impedance.

It is noted that capacitor 124 may be dispensed with for embodiments in which resonance is not measured. For example if noise is used as the temperature related property then the capacitor is not required.

As explained above, the signal circuit is used to send a signal from the microprocessor via the heating element and back to the microprocessor. The return signal is measured to determine the temperature of the heating element. It is appreciated that the microprocessor includes the necessary analog to digital and digital to analog converters to allow the measurements to be made.

The power supply line 102 supplies a relatively high voltage, whereas the measurement and detection components require a relatively low voltage. The power supply line is thus connected directly to the external phase voltage, and the signaling and like low power components are connected via a power supply arrangement which incorporates a diode bridge type rectifier 126 arranged between two parts 128 and 130 of a voltage divider. The consequent lowered power provides protection against electrocution.

Additional control for the power supply line 102 is provided by an isolated switching circuit 132 which is optically coupled to triac 134 on the power supply circuit. The switching circuit receives one of three control program signals M1, M2 and M4 from pin 6 of microcontroller 106. The three programs are a simple program—reach the temperature and stop an automatic program, reach the temperature and maintain it, and a timer program, maintain the temperature at the times indicated by the timer. Optical coupling from the control circuit 132 operates triac 108 and allows power to be supplied to heating element 100.

In a preferred embodiment, the microcontroller 106 has a music output, pin 15 in the figure, for playing music to a user who requests hot water, until the water has been heated up.

Typically, temperature measurements that are made can be read out via an LCD or like display device 140 which is connected to the microcontroller 106.

It is common in control installations to provide a battery back up so that the microprocessor continues to operate during a power failure and does not lose programming information. However a battery is a relatively large and expensive component and needs to be replaced if it is ever discharged. Unfortunately users are often left unaware that the battery has been discharged. In the preferred embodiment a large electrolytic capacitor 150 is connected in series with a large resistance 152. The combination of capacitor and resistor is capable of providing a microamp range current at two volts for a duration of several hours. Such a current is sufficient to power the microprocessor for any reasonable duration of power loss, and automatically recharges when power is restored.

In one preferred embodiment, the control system described herein is used in conjunction with a solar powered water heater. Actual temperature measurements of the water allow external electrical power to be used to supplement solar power only to the extent absolutely necessary, and no electricity is wasted.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. Apparatus for remotely obtaining a temperature of a fluid being heated by an electrical heating element, the apparatus comprising:
a switch for governing supply of electrical power to said heating element, said switch being controllable to stop the supply of said electrical power to said electrical heating element for a duration sufficient for said heating element to reach temperature equilibrium with said fluid,
a signal generation unit, coordinated with said switch, for sending an electrical signal to said heating element when said heating element has reached said temperature equilibrium, and
a measurement unit for measuring a measurable property of said electrical signal, said measurable property having a temperature dependency, to determine the temperature of said heating element and thereby to infer the temperature of said fluid.

2. Apparatus according to claim 1, wherein said electrical heating element comprises inductance and said property is associated with said inductance.

3. Apparatus according to claim 1, wherein said electrical heating element comprises inductance, and wherein a capacitive element is connected in at least one of a series connection and a parallel connection with said electrical heating element, thereby to create a temperature dependent deviation from resonance as said measurable property.

4. Apparatus according to claim 1, wherein said measurable property is resistance.

5. Apparatus according to claim 1, wherein said signal is a predefined signal and said measurable property is noise.

6. Apparatus according to claim 1, wherein said measurable property is impedance.

7. Apparatus according to claim 6, wherein said impedance is measured at a constant frequency.

8. Apparatus according to claim 6, wherein said impedance is measured at a fixed frequency.

9. Apparatus according to claim 1, wherein said measurable property is inductance.

10. Apparatus according to claim 1, further comprising a detector unit for measuring power being supplied to said heating element, thereby to provide an indication that said heating element is operational.

11. Apparatus according to claim 10, wherein said detector unit comprises an optical coupling to an isolated indicator circuit, said optical coupling being operational when power is supplied to said heating element to power said optical coupling to operate said indicator circuit.

12. Apparatus according to claim 11, wherein said detector unit comprises a voltage divider and a light emitting diode.

13. Apparatus according to claim 1, further comprising a power supply, said power supply comprising a diode-based rectification bridge, said bridge being connected between two impedance elements of a voltage divider.

14. Apparatus according to claim 1, further comprising a calibration table associated with said measurement unit, for calibrating measurements for a respective heating element.

15. Apparatus according to claim 1, further comprising an emergency power source, said emergency power source comprising a capacitance and a resistance connected in series, and having values selected to provide current in the microampere range at low voltage for a duration of several hours.

16. A method for remotely measuring the temperature of a fluid in contact with an electric heating element, the method comprising:
heating said fluid via said heating element,
cutting power to said heating element for sufficient time to allow said heating element to reach equilibrium temperature with said fluid,
applying a signal to said heating element,
taking a measurement of said signal, said measurement being of a temperature dependent property, therefrom to determine said equilibrium temperature of said heating element to infer said temperature of said fluid.

17. The method of claim 16, further comprising providing a capacitance in series with said heating element, thereby to provide a resonant circuit, and wherein said temperature dependent property is an impedance related deviation from a resonant frequency thereof.

18. The method of claim 16, wherein said signal comprises a defined waveform and said temperature dependent property is a noise level.

19. The method of claim 16, wherein said temperature dependent property is resistance.

20. The method of claim 16, wherein said temperature dependent property is inductance.

21. The method of claim 16, wherein said temperature dependent property is impedance.

22. The method of claim 16, further comprising a prior stage of calibrating for a respective heating element.

23. A control circuit for providing isolated control outputs to a microprocessor from a power circuit, comprising:
a triac having an anode, a gate and a cathode, said anode being connected to a power source of said power circuit,
a voltage divider connected between said cathode and said anode, arranged to operate an optical element depending upon a state of said power circuit,
said optical element providing an optical coupling to set an output voltage at a control output to control said microprocessor.

24. The control circuit of claim 23, wherein said voltage divider comprises a rectifier for providing rectified current to said optical element.
